(19) United States
(12) Patent Application Publication
(10) Pub. No.: US 2021/0347019 A1
(43) Pub. Date: Nov. 11, 2021

(54) AIR RATCHET WRENCH

(71) Applicant: Jian-Shiou LIAW, Taichung City (TW)

(72) Inventor: Jian-Shiou LIAW, Taichung City (TW)

(21) Appl. No.: 16/869,644

(22) Filed: May 8, 2020

(51) Int. Cl. B25B 21/00; B25B 13/46

(52) U.S. Cl. CPC B25B 21/004; B25B 13/465

(57) ABSTRACT

An air ratchet wrench has a body, a tool, and a restrictor. The body has two panels disposed at a spaced interval. Each panel has a through hole coaxially aligned with the through hole of the other panel. A first surface is located on a backside of one of the two panels away from the other panel, and a second surface is located on a backside of the other panel. The tool is assembled from the first surface, having a first end and a second end. The first end has an outer diameter larger than an inner diameter of the through hole of the panel that has the first surface. The second end passes through the two through holes, and protrudes on the second surface. The restrictor is sheathed on the tool and constrains the two panels from parting with the first end.

### BACKGROUND OF THE INVENTION

### 1. Field of the Invention

The present invention relates to a portable power-driven tool, and more particularly to an air ratchet wrench.

### 2. Description of Related Art

With reference to FIGS. 6 to 8, a conventional air ratchet wrench comprises a body 70, a tool 80, and a restrictor 90. The body 70 has a U-shaped assembly 71, a first surface 72, and a second surface 73. The U-shaped assembly 71 has two panels 711 disposed at a spaced interval and an opening 712 formed between the two panels 711. Each one of the two panels 711 has a through hole 713 disposed through the panel 711, and the two through holes 713 of the two panels 711 are coaxially aligned with each other. The first surface 72 and the second surface 73 are each located on a backside of a respective one of the two panels 711, wherein the backside of each one of the panels 711 is defined as a side away from the other panel 711. With reference to FIGS. 7 and 8, the first surface 72 is located on a bottom side of a lower one of the two panels 711, while the second surface 73 is located on a top side of an upper one of the two panels 711.

Furthermore, the tool 80 is inserted into the through hole 713 of the panel 711 where the first surface 72 is located from the first surface 72, and abuts the other panel 711 from bottom to top. The restrictor 90 is sheathed on the tool 80 on a portion thereof which is located in the opening 712, and abuts the lower panel 711, so as to mount the tool 80 on the two panels 711.

To conclude, the tool 80 is assembled to the U-shaped assembly 71 of the body 70 from the first surface 72, and with reference to FIGS. 7 and 8, the restrictor 90 abuts the lower panel 711 from top to bottom to limit the tool 80 from falling off from the two panels 711. After a long term of use, when the tool 80 is rotated to work on a workpiece, the tool 80 may be tilted due to a reaction force. The tilted tool 80 may prop the two panels 711 away from each other and damage the body 70. Consequently, the conventional air ratchet wrench is easily damaged, and becomes malfunctioned on tightening or loosening the workpiece after a period of use.

To overcome the shortcomings of the conventional air ratchet wrench, the present invention provides an air ratchet wrench.

### SUMMARY OF THE INVENTION

The main objective of the present invention is to provide an air ratchet wrench which solves the problem of the conventional air ratchet wrench and has a longer service life.

The air ratchet wrench has a body, a tool, and a restrictor. The body has a U-shaped assembly, a first surface, and a second surface. The U-shaped assembly has two panels disposed at a spaced interval and an opening formed between the two panels. Each one of the two panels has a through hole, and the two through holes of the two panels are coaxially aligned with each other. The first surface is located on a backside of a corresponding one of the two panels away from the other panel, and the second surface is located away from the first surface on a backside of a corresponding one of the two panels which the first surface is away from. The tool is assembled to the U-shaped assembly from the first surface, and has a first end and a second end. The first end of the tool has an outer diameter larger than an inner diameter of the through hole of the panel where the first surface of the body is located. The second end of the tool passes through the two through holes of the two panels and the opening, and protrudes on the second surface of the body. The restrictor is sheathed on the tool near the second end, and constrains the interval between the two panels from getting larger together with the first end of the tool.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of an air ratchet wrench in accordance with the present invention;

FIG. 2 is an exploded perspective view of the air ratchet wrench in FIG. 1;

FIG. 3 is a side view in partial section of the air ratchet wrench in FIG. 1;

FIG. 4 is an exploded perspective view of a second embodiment of an air ratchet wrench in accordance with the present invention;

FIG. 5 is an operational view of a restrictor of the air ratchet wrench in FIG. 4;

FIG. 6 is a perspective view of an air ratchet wrench in accordance with the prior art;

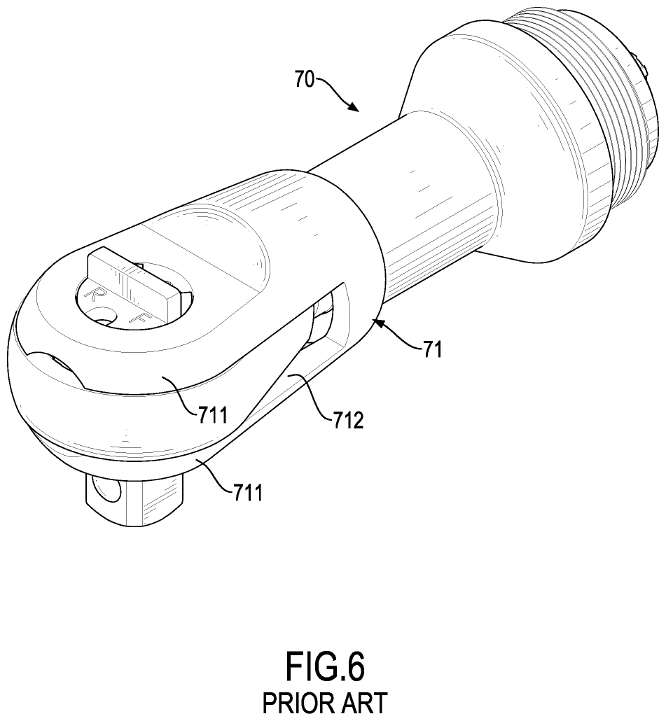

FIG. 7 is an exploded perspective view of the air ratchet wrench in FIG. 6; and

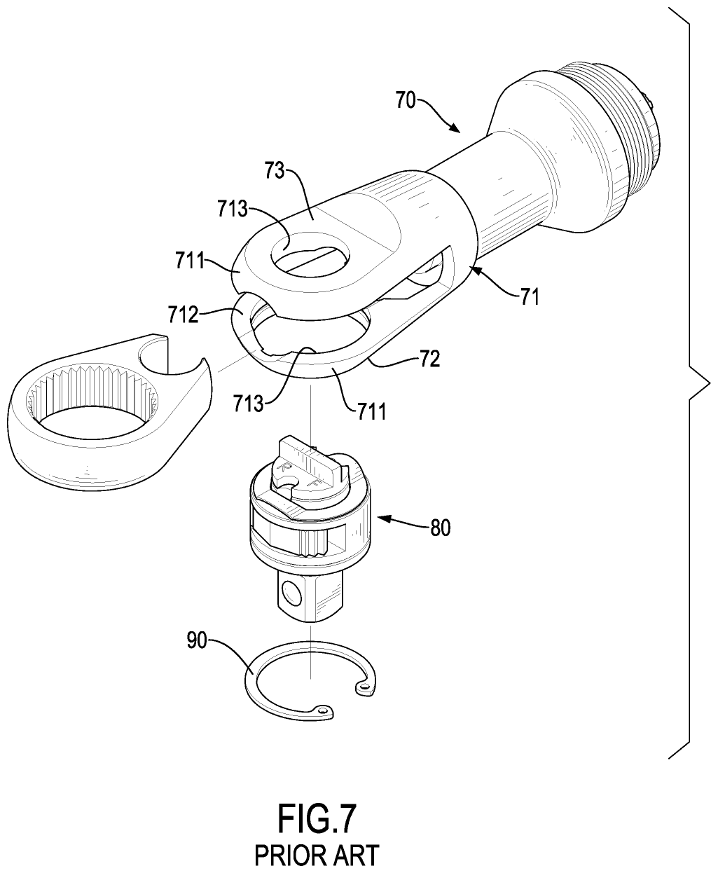

FIG. 8 is a side view in partial section of the air ratchet wrench in FIG. 6.

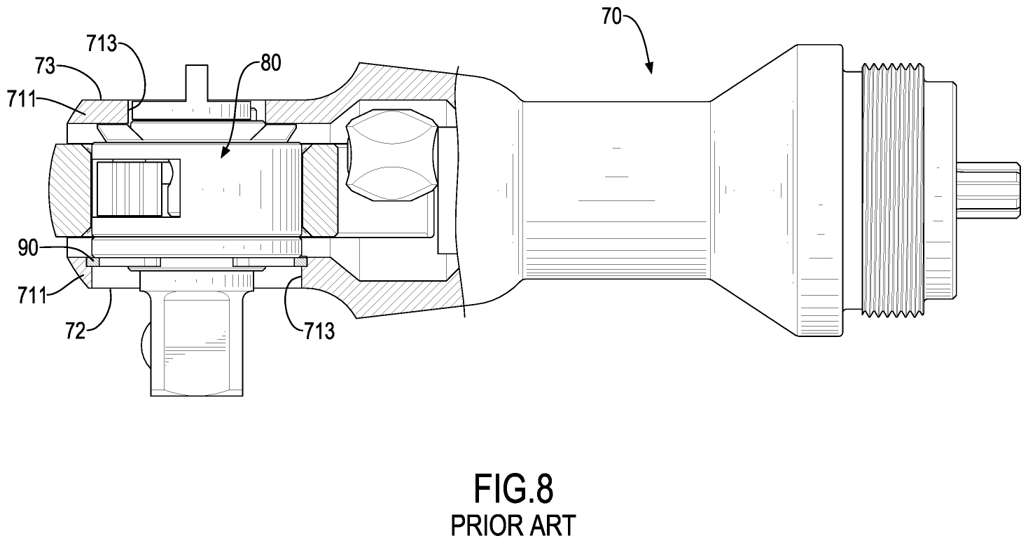

### DETAILED DESCRIPTION OF THE PREFERRED EMBODIMENT

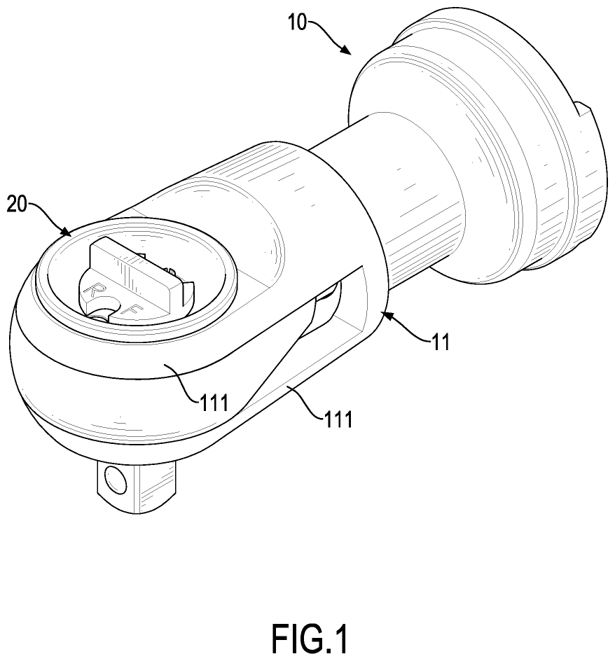

With reference to FIGS. 1 to 3, a first embodiment of an air ratchet wrench in accordance with the present invention comprises a body 10, a tool 20, and a restrictor 30.

The body 10 has a U-shaped assembly 11, a first surface 12, a second surface 13, a ring gear 14, and a driving shaft 15. The U-shaped assembly 11 has two panels 111 disposed at a spaced interval and an opening 112 formed between the two panels 111. Each one of the two panels 111 has a through hole 113, and the two through holes 113 of the two panels 111 are coaxially aligned with each other.

The first surface 12 is located on a backside of one of the two panels 111 away from the other panel 111, and the second surface 13 is located away from the first surface 12 on a backside of the other one of the two panels 111 which the first surface 12 is away from. With reference to FIGS. 1 to 3, the first surface 12 is located on a top side of an upper one of the two panels 111, while the second surface 13 is located on a bottom side of a lower one of the two panels 111.

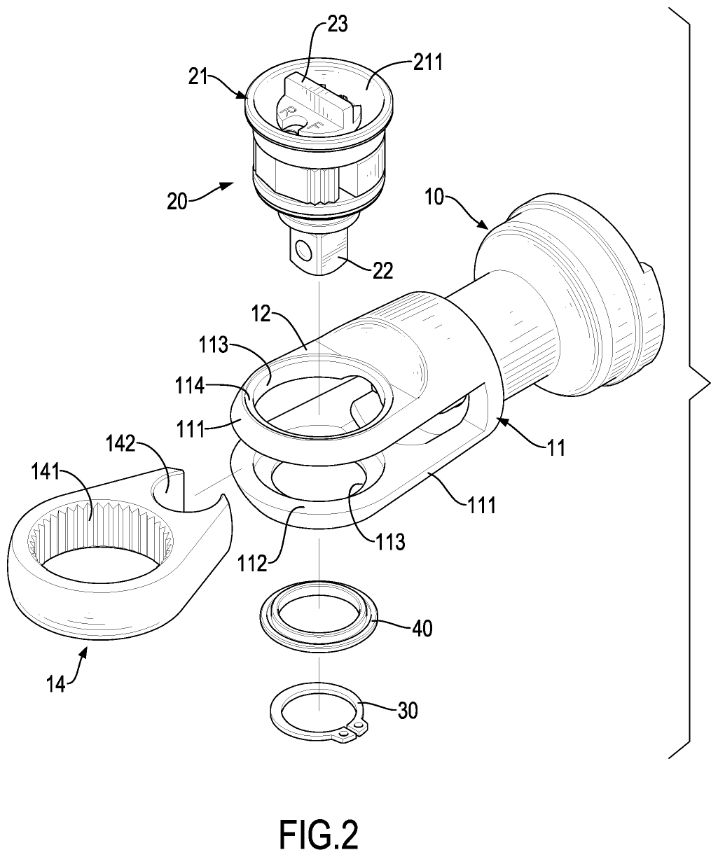

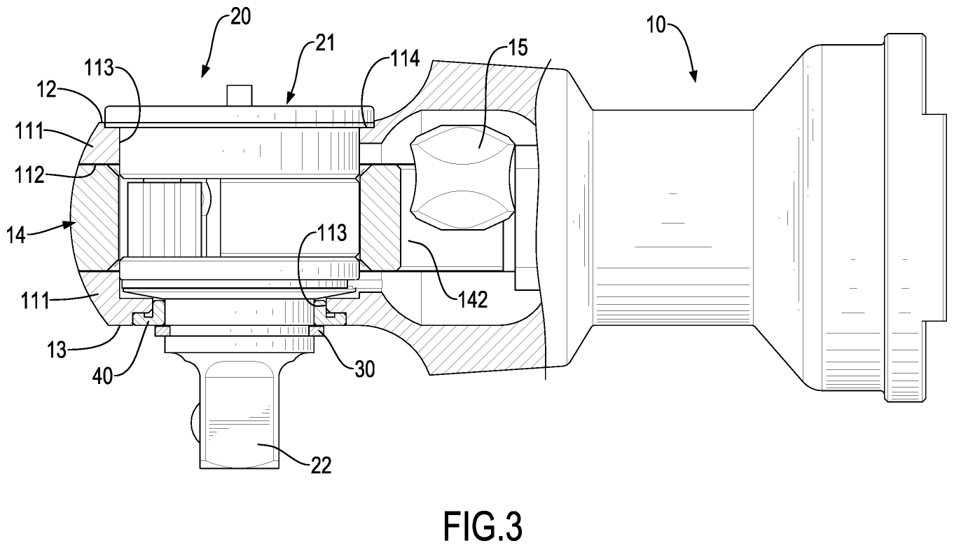

With reference to FIGS. 2 and 3, the ring gear 14 is mounted in the opening 112 between the two panels 111 of the U-shaped assembly 11. The ring gear 14 has a hole 141, an inner ratchet, and a groove 142. The hole 141 is centrally disposed through the ring gear 14. The inner ratchet is formed on an interior surface of the hole 141. Moreover, with reference to FIG. 3, the hole 141 is coaxial to the two through holes 113 of the two panels 111. The groove 142 is disposed on a side of the ring gear 14. The driving shaft 15 is assembled in the body 10. An end of the driving shaft 15 extends into the groove 142 of the ring gear 14 through the U-shaped assembly 11, so the ring gear 14 may be swung by the driving shaft 15 when the driving shaft 15 is rotated.

With reference to FIGS. 2 and 3, the tool 20 is assembled to the U-shaped assembly 11 from the first surface 12 of the body 10, passes through the two through holes 113 of the two panels 111 and the hole 141 of the ring gear 14, engages with the inner ratchet, and protrudes on the second surface 13 of the body 10. The tool 20 has a first end 21 and a second end 22. The first end 21 of the tool 20 has a circular rib radially protruded outwardly. The circular rib has an outer diameter larger than an inner diameter of the through hole 113 of the panel 111 where the first surface 12 is located (i.e. the upper one of the two panels 111 as shown in FIGS. 1 to 3), so the tool 20 cannot fully pass through the through hole 113 of the upper panel 111. As a result, the tool 20 may be positioned on the body 10.

The second end 22 of the tool 20 is a part of the tool 20 away from the first end 21 for tightening or loosening a workpiece. With reference to FIG. 3, the second end 22 of the tool 20 passes through the two through holes 113 of the two panels 111 and the hole 141 of the ring gear 14 in the opening 112, and protrudes on the second surface 13 of the body 10. When the ring gear 14 swings, the inner ratchet in the hole 141 may unidirectionally rotate the tool 20, so as to tighten or loosen the workpiece via the second end 22 of the tool 20.

With reference to the first embodiment of the present invention, the tool 20 further comprises an arched trough 211 and a direction switch 23. The arched trough 211 is disposed on the first end 21 of the tool 20 away from the second end 22 of the tool 20. The direction switch 23 is mounted in the arched trough 211 of the first end 21 for switching a rotating direction of the tool 20 which is driven by the ring gear 14. Working principles of the direction switch 23 are conventional, so detailed description thereof is omitted.

Furthermore, with reference to FIGS. 2 and 3, in the first embodiment of the present invention, the panel 111 where the first surface 12 of the body 10 is located (i.e. the upper one of the two panels 111) has a stepped edge 114 disposed near the through hole 113 of the upper one of the two panels 111. The stepped edge 114 has an inner diameter larger than or equal to the outer diameter of the circular rib of the first end 21 of the tool 20. The tool 20 is thereby well positioned because the circular rib of the first end 21 of the tool 20 abuts the stepped edge 114 and is located within the stepped edge 114 of the body 10.

With reference to FIGS. 2 and 3, the restrictor 30 is mounted on the tool 20 near the second end 22, and constrains the interval between the two panels 111 from getting larger together with the first end 21 of the tool 20. Moreover, the two panels 111 are constrained to be parallel with each other by the restrictor 30, the first end 21 of the tool 20, and the ring gear 14. In the first embodiment of the present invention, the restrictor 30 is a C ring sheathed on the tool 20.

Besides, the air ratchet wrench of the present invention may further comprise a washer 40. The washer 40 is sheathed on the tool 20 near the second end 22, and abuts the tool 20 and the panel 111 where the second surface 13 is located (i.e. the lower one of the two panels 111) in a direction from the second end 22 toward the first end 21 of the tool 20. The restrictor 30 abuts the washer 40 from bottom, and props the lower one of the two panels 111 via the washer 50, so as to constrain the interval between the two panels 111 from getting larger. As a consequence, the interval between the two panels 111 are well maintained, and reaction force from the workpiece will not cause the tool 20 to be tilted and separate the two panels 111 from each other.

The restrictor 30 may have an outer diameter which is larger than that of the through hole 113 of the lower one of the two panels 111. In this way, the washer 40 is not essential to the air ratchet wrench in accordance with the present invention and may be omitted. The restrictor 30 may directly abut on the second surface 13 of the body 10, so as to constrain the deformation of the two panels 111 together with the first end 21 of the tool 20.

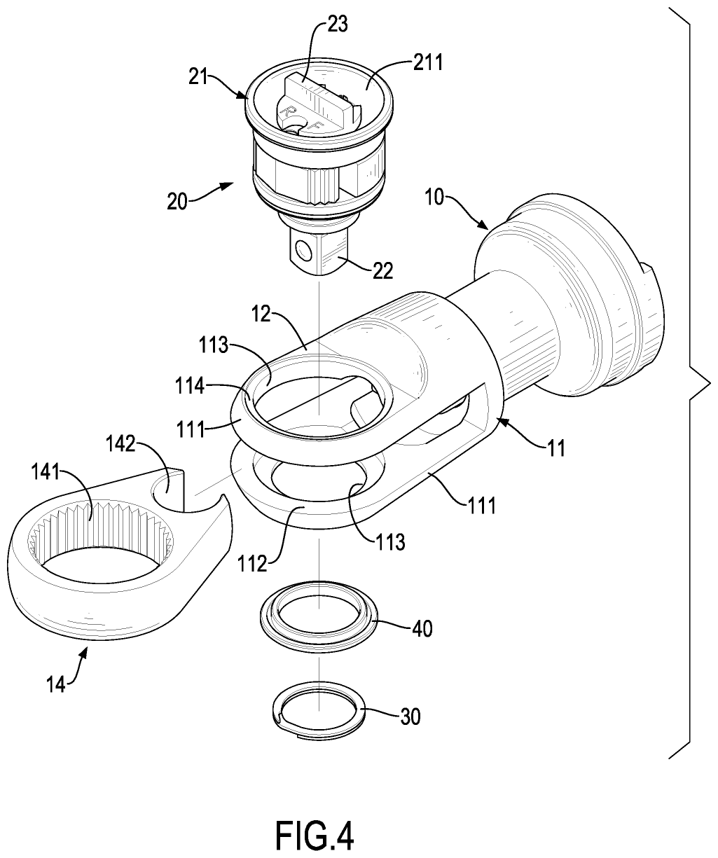

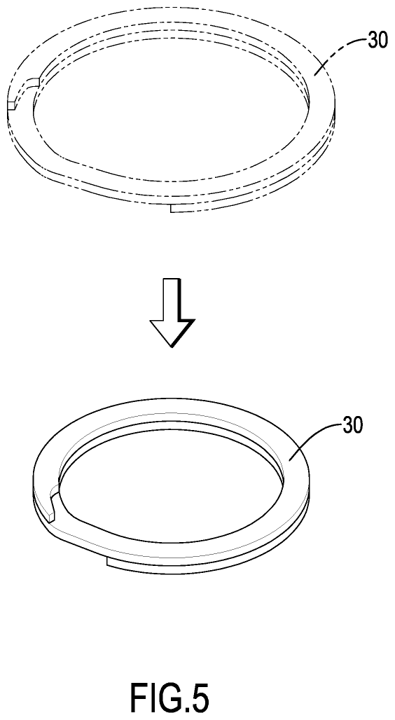

With reference to FIGS. 4 and 5, in a second embodiment of an air ratchet wrench of the present invention, the restrictor 30 is a radially expandable spring sheathed on the tool 20. The radially expandable spring may be enlarged from inside to outside. When an inner diameter of the radially expandable spring becomes larger than an outer diameter of the second end 22 of the tool 20, the radially expandable spring may be put around the tool 20 via the second end 22. After a force enlarging the radially expandable spring is removed, due to elastic resilience, the inner diameter of the radially expandable spring shirks once again. The radially expandable spring is thereby sheathed on the tool 20.

Besides, the restrictor 30 may be a pin inserted on the tool 20 near the second end 22, so as to constrain the interval between the two panels 111 from getting larger together with the first end 21 of the tool 20.

With the aforementioned technical characteristics, the air ratchet wrench in accordance with the present invention is provided with a service life longer than the conventional air ratchet wrench, because the first end 21 of the tool 20 and the restrictor 30 may constrain the two panels 111 of the body 10 from parting. As a result, the tool 20 will not become tilted by a reaction force, and the body 10 will not be damaged by the tilted tool 20. This ensures that even after a long term of use, the air ratchet wrench in accordance with the present invention may still provide a good effect on tightening or loosening a workpiece.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An air ratchet wrench comprising:
a body having
a U-shaped assembly having
two panels disposed at a spaced interval, each one of the two panels having a through hole, and the two through holes of the two panels coaxially aligned with each other; and
an opening formed between the two panels;
a first surface located on a backside of one of the two panels away from the other panel; and
a second surface located away from the first surface on a backside of the other one of the two panels which the first surface is away from;
a tool assembled to the U-shaped assembly from the first surface, and having
a first end whose outer diameter is larger than an inner diameter of the through hole of the panel where the first surface is located; and
a second end passing through the two through holes of the two panels and the opening, and protruding on the second surface of the body; and
a restrictor mounted on the tool near the second end, and constraining the interval between the two panels from getting larger together with the first end of the tool.

2. The air ratchet wrench as claimed in claim 1, wherein
the body has a ring gear mounted in the opening between the two panels of the U-shaped assembly, and the ring gear has
a hole disposed therethrough; and
an inner ratchet formed on an interior surface of the hole;
the tool passes through the hole, and engages with the inner ratchet.

3. The air ratchet wrench as claimed in claim 2, wherein the two panels are constrained to be parallel with each other by the restrictor, the first end of the tool, and the ring gear.

4. The air ratchet wrench as claimed in claim 2, wherein the body has a driving shaft assembled in the body, and the ring gear is swung by the driving shaft when the driving shaft is rotated.

5. The air ratchet wrench as claimed in claim 1, wherein the restrictor is one of a C ring and a radially expandable spring, and is sheathed on the tool.

6. The air ratchet wrench as claimed in claim 1, wherein the tool has
an arched trough disposed on the first end of the tool; and
a direction switch mounted in the arched trough of the first end for switching a rotating direction of the tool.

7. The air ratchet wrench as claimed in claim 2, wherein the tool has
an arched trough disposed on the first end of the tool; and
a direction switch mounted in the arched trough of the first end for switching a rotating direction of the tool.

8. The air ratchet wrench as claimed in claim 3, wherein the tool has
an arched trough disposed on the first end of the tool; and
a direction switch mounted in the arched trough of the first end for switching a rotating direction of the tool.

9. The air ratchet wrench as claimed in claim 4, wherein the tool has
an arched trough disposed on the first end of the tool; and
a direction switch mounted in the arched trough of the first end for switching a rotating direction of the tool.

10. The air ratchet wrench as claimed in claim 5, wherein the tool has
an arched trough disposed on the first end of the tool; and
a direction switch mounted in the arched trough of the first end for switching a rotating direction of the tool.

11. The air ratchet wrench as claimed in claim 1, wherein
the panel where the first surface is located has
a stepped edge disposed near the through hole of the panel; and
the first end of the tool has
a circular rib radially protruded, and having
an outer diameter smaller than or equal to an inner diameter of the stepped edge; and
the circular rib of the first end abuts the stepped edge.

12. The air ratchet wrench as claimed in claim 2, wherein
the panel where the first surface is located has
a stepped edge disposed near the through hole of the panel; and
the first end of the tool has
a circular rib radially protruded, and having
an outer diameter smaller than or equal to an inner diameter of the stepped edge; and
the circular rib of the first end abuts the stepped edge.

13. The air ratchet wrench as claimed in claim 3, wherein
the panel where the first surface is located has
a stepped edge disposed near the through hole of the panel; and
the first end of the tool has
a circular rib radially protruded, and having
an outer diameter smaller than or equal to an inner diameter of the stepped edge; and
the circular rib of the first end abuts the stepped edge.

14. The air ratchet wrench as claimed in claim 4, wherein
the panel where the first surface is located has
a stepped edge disposed near the through hole of the panel; and
the first end of the tool has
a circular rib radially protruded, and having
an outer diameter smaller than or equal to an inner diameter of the stepped edge; and
the circular rib of the first end abuts the stepped edge.

15. The air ratchet wrench as claimed in claim 5, wherein
the panel where the first surface is located has
a stepped edge disposed near the through hole of the panel; and
the first end of the tool has
a circular rib radially protruded, and having
an outer diameter smaller than or equal to an inner diameter of the stepped edge; and
the circular rib of the first end abuts the stepped edge.

16. The air ratchet wrench as claimed in claim 1, wherein
the air ratchet wrench has
a washer sheathed on the tool near the second end, and abutting the tool and the panel where the second surface is located in a direction from the second end of the tool toward the first end of the tool; and
the restrictor abuts the washer.

17. The air ratchet wrench as claimed in claim 2, wherein
the air ratchet wrench has
a washer sheathed on the tool near the second end, and abutting the tool and the panel where the second surface is located in a direction from the second end of the tool toward the first end of the tool; and
the restrictor abuts the washer.

18. The air ratchet wrench as claimed in claim 3, wherein
the air ratchet wrench has
a washer sheathed on the tool near the second end, and abutting the tool and the panel where the second surface is located in a direction from the second end of the tool toward the first end of the tool; and
the restrictor abuts the washer.

19. The air ratchet wrench as claimed in claim 4, wherein
the air ratchet wrench has
a washer sheathed on the tool near the second end, and abutting the tool and the panel where the second surface is located in a direction from the second end of the tool toward the first end of the tool; and
the restrictor abuts the washer.

20. The air ratchet wrench as claimed in claim 5, wherein
the air ratchet wrench has
a washer sheathed on the tool near the second end, and abutting the tool and the panel where the second surface is located in a direction from the second end of the tool toward the first end of the tool; and
the restrictor abuts the washer.
